(19) United States
(12) Patent Application Publication
(10) Pub. No.: US 2011/0004332 A1
(43) Pub. Date: Jan. 6, 2011

(54) METHOD OF DESIGNING A CONCRETE COMPOSITIONS HAVING DESIRED SLUMP WITH MINIMAL WATER AND PLASTICIZER

(75) Inventor: Per Just Andersen, Santa Barbara, CA (US)

Correspondence Address: Patent Docket Department;Armstrong Teasdale LLP, 7700 Forsyth Boulevard, Suite 1800, St. Louis, MO, 63105, US

(73) Assignee: ICRETE INTERNATIONAL, INC., Road Town (VG)

(21) Appl. No.: 12/496,529

(22) Filed: Jul. 1, 2009

(51) Int. Cl. G06F 17/50; G05D 11/13

(52) U.S. Cl. 700/103; 700/265

(57) ABSTRACT

Methods of preparing design-optimized concrete compositions having target compressive strengths and slumps with a minimal amount of water are disclosed. In particular, the optimized concrete compositions are produced by analyzing pre-existing mix designs from a manufacture and determining the optimum amount of water required in the mix (i.e., optimized water to cement ratio) to obtain a target slump, yet allowing for the end-produced concrete composition to have a target compressive strength.

### BACKGROUND OF THE DISCLOSURE

The disclosure relates generally to methods for design-optimization of concrete compositions based on factors such as performance and cost. In particular, the methods allow for designing and manufacturing of concrete compositions having target compressive strengths and slumps using minimal amounts of water and cement using improved methods that more efficiently utilize all the components from a performance and cost standpoint, as well as unique methods for redesigning an existing cementitious composition design and upgrading the batching, mixing, and/or delivery system of an existing concrete manufacturing plant.

Concrete is a ubiquitous building material. Finished concrete (also referred to herein as concrete composition) results from the hardening of an initial cementitious composition that typically comprises cement (typically, hydraulic cement), aggregate, water, and optional admixtures. The terms “concrete”, “concrete composition” and “concrete mixture” shall mean either the finished, hardened product of the initial unhardened cementitious composition or “mix design”, which is the formula or recipe used to manufacture a concrete composition. In a typical process for manufacturing transit mixed concrete, the concrete components are added to and mixed in a drum, either of a central mixer or of a standard concrete delivery truck while the truck is in transit to the delivery site. Hydraulic cement reacts with water to form a binder that hardens over time to hold the other components together.

Concrete can be designed to have varying strength, slump, and other material characteristics, which gives it broad application for a wide variety of different uses. The raw materials used to manufacture cement and concrete are relatively inexpensive and can be found virtually everywhere, although the characteristics of the materials can vary significantly. This allows concrete to be manufactured throughout the world close to where it is needed. The same attributes that make concrete ubiquitous (i.e., low cost, ease of use, and wide availability of raw materials) have also kept it from being fully controlled and its full potential developed and exploited.

Concrete manufacturing plants typically offer and sell a number of different standard concrete compositions that vary in terms of their slump and strength. Each concrete composition is typically manufactured by following a standard mix design, or recipe, to yield a composition that has the target slump and that will harden into concrete having the target compressive strength. Unfortunately, there is often high variability between the predicted (or design) compressive strength and/or slump of a given mix design and the actual strength and/or slump between different batches with a high standard deviation in compressive strength between batches, even in the absence of substantial variability in the quality or characteristics of the raw material inputs. Part of this problem results from a fundamental disconnect between the requirements, controls and limitations of “field” operations in the concrete batch plant and the expertise from research under laboratory conditions. Whereas experts may be able to design a concrete composition having a predicted compressive strength and/or slump that closely reflects actual compressive strength and/or slump when mixed, cured and tested, experts do not typically prepare concrete compositions at concrete plants for delivery to customers. Concrete personnel who batch, mix and deliver concrete to job sites inherently lack the ability to control the typically large variation in raw material inputs that is available when conducting laboratory research. The superior knowledge of concrete by laboratory experts is therefore not readily applicable or transferable to the concrete industry in general.

In general, concrete compositions are designed based on such factors as (1) type of hydraulic cement, (2) type and quality of aggregates, (3) quantity and quality of water, and (4) climate (e.g., temperature, humidity, wind, and amount of sun, all of which can cause variability in slump, workability, and compressive strength of concrete). To guarantee a specific minimum compressive strength and slump as required by the customer (and avoid liability in the case of failure), concrete manufacturers typically follow a process referred to as “overdesign” of the concrete they sell. For example, if the 28-day field compressive strength of a particular concrete mix design is known to vary by about 10%, 20%, 40%, 60%, or even more when manufactured and delivered, a manufacturer must typically provide the customer with a concrete composition based on a mix design that achieves a strength of 4000 psi when cured under controlled laboratory conditions to guarantee the customer a minimum strength of 2500 psi through the commercial process. Failure to deliver concrete having the minimum required strength can lead to structural problems, even failure, which, in turn, can leave a concrete plant legally responsible for such problems or failure. Thus, overdesigning is self insurance against delivering concrete that is too weak, with a cost to the manufacturer equal to the increased cost of overdesigned concrete. This cost must be absorbed by the owner, does not benefit the customer, and, in a competitive supply market, cannot easily be passed on to the customer.

Overdesigning typically involves adding excess cement in an attempt to ensure a minimum acceptable compressive strength of the final concrete product at the target slump. Because cement is typically the most expensive component of concrete (besides special admixtures that are frequently used in relatively high amounts), the practice of overdesigning concrete can significantly increase cost. However, adding more cement does not guarantee better concrete, as the cement paste binder is often a lower compressive strength structural component compared to aggregates and the component subject to the greatest dynamic variability. Overcementing can result in short term microshrinkage, excessive drying shrinkage, and long term creep. Notwithstanding the cost and potentially deleterious effects, it is current practice for concrete manufacturers to simply overdesign by adding excess cement to each concrete composition it sells as it is easier than to try and redesign each standard mix design (which, standard practice does not allow). That is, because there is currently no reliable- or systematic way to optimize a manufacturer's pre-existing mix designs other than through time-consuming and expensive trial and error testing to make more efficient use of the hydraulic cement binder and/or account for variations in raw material inputs, manufacturers are required to adequately overdesign the pre-existing mix designs, leading to increased costs and excessive waste of materials.

The cause of observed strength and slump variabilities is not always well understood, nor can it be reliably controlled using existing equipment and following standard protocols at typical ready-mix manufacturing plants. Typically, concrete manufacturers do not even realize that improved concrete compositions can be made with their existing equipment. Furthermore, understanding the interrelationship and dynamic effects of the different components within concrete is typically outside the capability of concrete manufacturing plant employees and concrete truck drivers using existing equipment and procedures. Moreover, what experts in the field of concrete might know, or believe they know, about concrete manufacture, cannot readily be transferred into the minds and habits of those who actually work in the field (i.e., those who place concrete mixtures into concrete delivery trucks, those who deliver the concrete to a job site, and those who place and finish the concrete at job sites) because of the tremendous difference in controls and scope of materials variation. The disconnect between what occurs in a laboratory and what actually happens during concrete manufacture can produce flawed mix designs that, while apparently optimized when observed in the laboratory, may not be optimized in reality when the mix design is scaled up to mass produce concrete over time.

Besides variability resulting from poor initial mix designs, another reason why concrete plants deliberately have to overdesign concrete is the inability to maintain consistency of manufacture. There are three major systemic causes or practices that have historically lead to substantial concrete strength variability: (1) the use of materials that vary in quality and/or characteristics; (2) the use of inconsistent batching procedures; and (3) adding insufficient batch water initially and later making slump adjustments with water at the job site, typically by the concrete truck driver adding an uncontrolled amount of water to the mixing drum. The total variation in materials and practices can be measured by standard deviation statistics.

The first cause of variability between theoretical and actual concrete strengths and slumps for a given mix design is variability in the supply of raw materials. For example, the particle size distribution, morphology, specific gravity and absorbance of aggregates (e.g., course, medium, and fine), and particle packing density of the hydraulic cement and aggregates may vary from batch to batch. Even slight differences can greatly affect how much water must be added to yield a composition having the required slump. Because concrete strength is highly dependent on the water to cement ratio, varying the water content to account for variations in the solid particle characteristics to maintain the required slump causes substantial variability in concrete strength. Unless a manufacturer can eliminate variations in raw material quality, overdesigning is generally the only available way to ensure that a concrete composition having the required slump also meets the minimum compressive strength requirements.

Even if a concrete manufacturer accounts for variations in raw materials' quality, overdesigning is still necessary using standard mix design tables manufactured under ACI 211. Standardized tables are based on actual mix designs using one type and morphology of aggregates that have been prepared and tested. They provide slump and strength values based on a wide variety of variables, such as amounts of cement, aggregates, water, and any admixtures, as well as the size of the aggregates. The use of standardized tables is fast and simple but can only approximate actual slump and compressive strength even when variations in raw materials are measured. That is, because the number of standardized mix designs is finite though the variability in the type, quality and amount (i.e., ratio) of raw materials is virtually infinite. Because standardized tables can only approximate real world raw material inputs, there can be significant variability between predicted and actual strength when using mix designs from standardized tables. Because of this variability, the only two options are (1) time consuming and expensive trial and error testing to find an optimal mix design for every new batch of raw materials or (2) overdesigning. Manufacturers typically have no choice other than overdesigning, especially in light of factors other than mix design that cause variations between design and actual strength.

The second cause of strength variability is the inability to accurately deliver the components required to properly prepare each batch of concrete. Initially, many times manufacturers are unaware that their equipment cannot accurately weigh the components. Furthermore, even if modern scales can theoretically provide very accurate readings, sometimes to within 0.05% of the true or actual static weight, typical hoppers and other dispensing equipment used to dispense the components into the mixing vessel (e.g., the drum of a concrete mixer truck) are often unable to consistently open and shut at the precise time in order to ensure that the desired quantity of a given component is actually dynamically dispensed into the mixing vessel. To many concrete manufacturers, even if they realize improved concrete compositions can be made (which, noted above, most do not), the perceived cost of upgrading or properly calibrating their metering and dispensing equipment is higher than simply overdesigning the concrete, particularly since most manufacturers have no idea how much the practice of overdesigning concrete actually costs and because it is thought to be a variable cost rather than a capital cost.

The third cause of concrete strength variability is the practice by concrete truck drivers of adding water to concrete after batching in an attempt to improve or modify the concrete to make it easier to pour, pump, work, and/or finish. In many cases, concrete is uniformly designed and manufactured to have a standard slump (e.g., 1-4 inches) when the concrete truck leaves the lot, with the expectation that the final slump requested by the customer will be achieved on site through the addition of water. This procedure is imprecise because concrete drivers rarely, if ever, use a standard slump cone to actually measure the slump but simply go on “look and feel”. Since adding water significantly decreases final concrete compressive strength, the concrete plant must build in a corresponding amount of increased initial strength to offset the possible or expected decrease in strength resulting from subsequent water addition.

Furthermore, the amount of moisture in the components of a concrete composition can vary significantly depending on the specific components utilized. Specifically, depending on delivery, weather conditions, and storage conditions, total moisture in the sand and aggregate can vary substantially. Typically, a manufacturer does not have the equipment to accurately measure the moisture content within these components, and in some cases, even if the equipment is available, it is not used. Overall, this lack of instrumentation leads to a variation from batch to batch in both free water content and solids content of sand and aggregate. Because strength can be decreased by varying amounts depending on the actual amount of water added by the driver and/or unaccounted for moisture already within the components, the manufacturer must assume a worst-case scenario of maximum strength loss when designing the concrete in order to ensure that the concrete meets or exceeds the required strength.

Given the foregoing variables, which can differ in degree and scope from day to day, a concrete manufacturer may believe it to be more practical to overdesign its concrete compositions rather than account and control for the variables that can affect concrete strength, slump and other properties. Overdesigning, however, is wasteful as an inefficient use of raw materials and adds extra costs to the manufacturer.

Accordingly, there is a need in the art for a design-optimized concrete composition that can be prepared consistently to have a target compressive strength and slump. It would be advantageous if the concrete composition could be made with a minimal amount of water and cement to prevent the consequences of overhydrating the composition as described above.

### BRIEF DESCRIPTION OF THE DISCLOSURE

The present disclosure is generally related to methods of preparing design-optimized concrete compositions having target compressive strengths and slumps with a minimal amount of water (i.e., optimized water to cement ratio) and cement. In particular, the concrete compositions are produced by analyzing pre-existing mix designs from a manufacture and determining the optimum amount of water required in the mix (also referred to herein, as dry cementitious composition) to obtain a target slump, yet allowing for the end-produced concrete composition to have a target compressive strength.

Accordingly, in one aspect, the present disclosure is directed to a method for designing a concrete composition having optimized compressive strength and slump. The method comprises: preparing at least one saturated-surface-dry cementitious composition having a compressive strength in a target compressive strength range, the saturated-surface-dry cementitious composition comprising cement, fine aggregate, and coarse aggregate; determining an amount of water to be added to the saturated-surface-dry cementitious composition to produce a target slump amount; preparing at least two initial concrete compositions having the amount of water and the target slump amount; measuring the compressive strength of the initial concrete compositions after a desired time; determining an amount of overdesign compressive strength for the initial concrete compositions; and determining an optimized water to cement ratio for an overdesigned optimized concrete composition.

In another aspect, the present disclosure is directed to a method for designing a concrete composition having optimized compressive strength and slump. The method comprises: obtaining a characterization of at least one component of a saturated-surface-dry cementitious composition, the saturated-surface-dry cementitious composition comprising cement, fine aggregate, and coarse aggregate; preparing the saturated-surface-dry cementitious composition having a compressive strength in a target compressive strength range; determining an amount of water to be added to the saturated-surface-dry cementitious composition to produce a target slump amount; preparing at least two initial concrete compositions having the amount of water and the target slump amount; measuring the compressive strength of the initial concrete compositions after a desired time; determining an amount of overdesign compressive strength for the initial concrete compositions; and determining an optimized water to cement ratio for an overdesigned optimized concrete composition.

In yet another aspect, the present disclosure is directed to a method for designing a concrete composition having optimized compressive strength and slump. The method comprises: obtaining a characterization of at least one component of a saturated-surface-dry cementitious composition, the saturated-surface-dry cementitious composition comprising cement, fine aggregate, and coarse aggregate; introducing at least one moisture probe into a fine aggregate hopper and at least one moisture probe into a coarse aggregate hopper, the fine aggregate hopper and coarse aggregate hopper each being used to prepare the saturated-surface-dry cementitious composition; preparing at least one saturated-surface-dry cementitious composition having a compressive strength in a target compressive strength range; determining an amount of water to be added to the saturated-surface-dry cementitious composition to produce a target slump amount; preparing at least two initial concrete compositions having the amount of water and the target slump amount; measuring the compressive strength of the initial concrete composition after a desired time; determining an amount of overdesign compressive strength for the initial concrete compositions; and determining an optimized water to cement ratio for an overdesigned optimized concrete composition.

In yet another aspect, the present disclosure is directed to a system. The system comprises a memory for storing data related to a saturated-surface-dry cementitious composition and a processor configured to: (1) receive data from an operator related to the saturated-surface-dry cementitious composition; (2) calculate an amount of water to be added to the saturated-surface-dry cementitious composition to produce a target slump; (3) receive data from an operator related to compressive strength; (4) calculate an amount of overdesign compressive strength; (5) calculate an optimized water to cement ratio for an overdesigned optimized concrete composition; and (6) provide the calculated amount of water to be added to the saturated-surface-dry cementitious composition to produce a target slump, the calculated amount of overdesign of compressive strength, and the calculated optimized water to cement ratio for the overdesigned optimized concrete composition for display.

Other objects and features will be in part apparent and in part pointed out hereinafter.

### BRIEF DESCRIPTION OF THE DRAWINGS

FIG. 1 depicts a precise “fingerprint” of strength versus water to cement ratio for an exemplary manufacturer/customer that has previously been setup to batch with the approach described herein;

FIG. 2 depicts the water demand for 2″ slump as a function of water to cement ratio as determined in Example 1;

FIG. 3 depicts anticipated slump for final mixes as a function of water to cement ratio with a water content of 280 lbs as determined in Example 1; and

FIG. 4 depicts 3, 7, and 28-day compressive strength as a function of water to cement ratio as analyzed in Example 1.

FIG. 5 depicts 3, 7, and 28-day compressive strength as a function of water to cement ratio as analyzed in Example 2.

FIG. 6 depicts 3, 7, and 28-day compressive strength as a function of water to cement ratio as analyzed in Example 3.

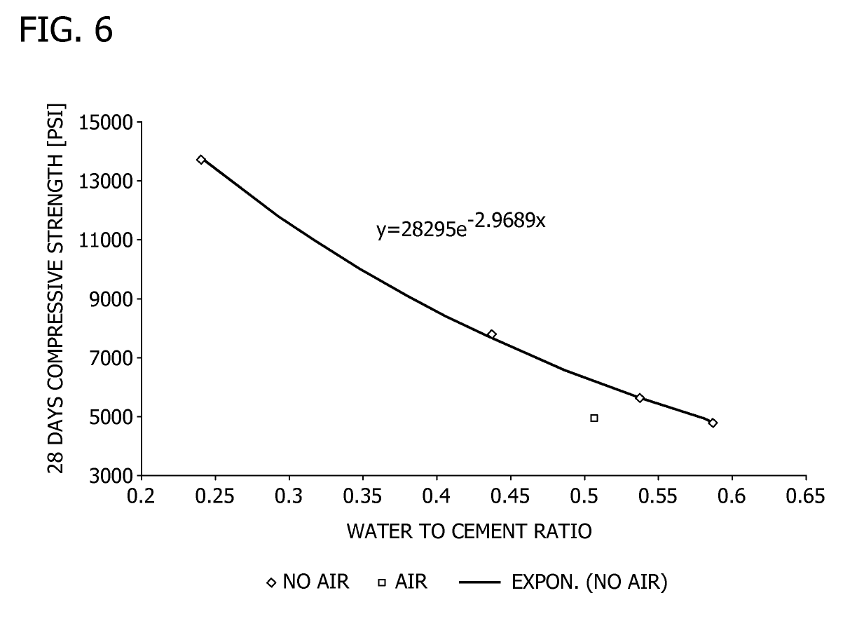

FIG. 7 depicts 3, 7, and 28-day compressive strength as a function of water to cement ratio as analyzed in Example 4.

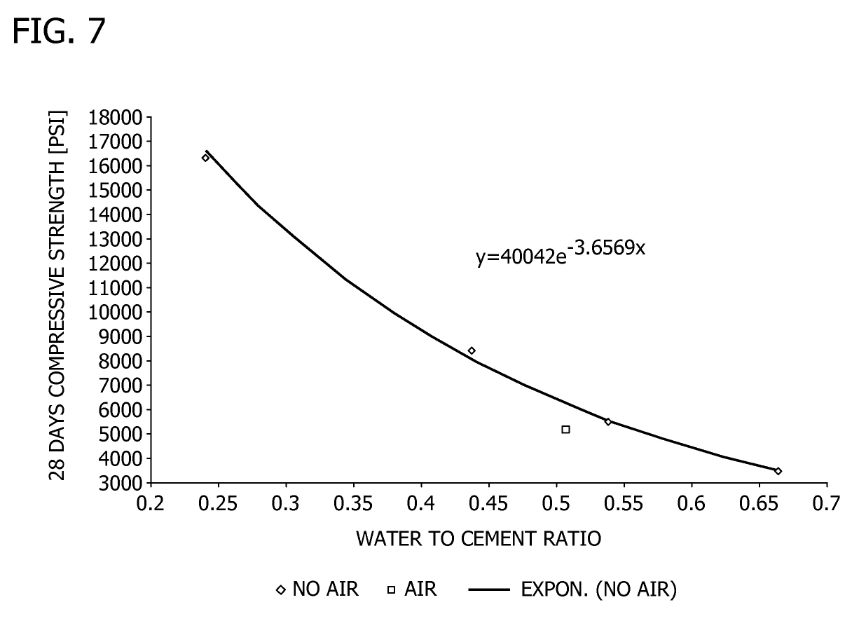

FIG. 8 depicts 3, 7, and 28-day compressive strength as a function of water to cement ratio as analyzed in Example 5.

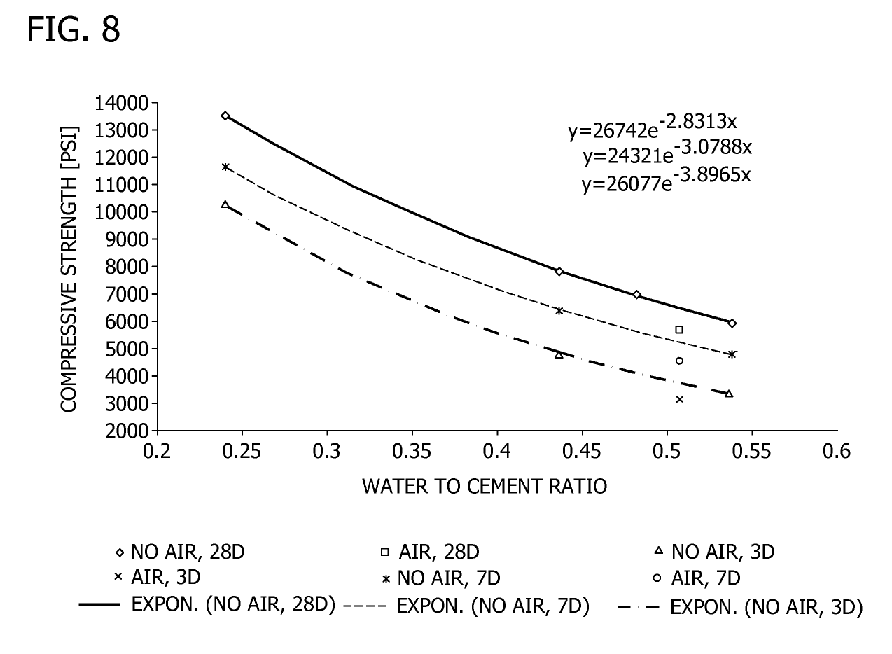

FIG. 9 depicts a system diagram of one embodiment of the present disclosure.

FIG. 10 depicts a flow chart tracking the steps of one embodiment of the present disclosure.

### DETAILED DESCRIPTION OF THE DISCLOSURE

It has been found that concrete compositions can be manufactured to include minimal cementitious raw materials while achieving a target compressive strength and slump. More particularly, as compared to conventional methods for designing concrete compositions using standardized tables under ACI 211, the methods of the present disclosure more precisely considers the actual characteristics of raw materials utilized by a concrete manufacturer. Standardized tables only roughly approximate actual slump and compressive strength because the characteristics of raw materials presumed in the tables rarely, if ever, reflect the true characteristics of raw materials actually used by a concrete manufacturer. Each concrete manufacturing plant utilizes raw materials that are unique to that plant, and it is unreasonable to expect standardized tables to accurately account for materials variability among different plants. The present methods are able to virtually “test” mix designs that more accurately reflect the raw materials actually utilized by the plant at a given time. By accounting for variations in the quality of raw materials, the methods are able to substantially reduce the degree of overdesigning of concrete compositions that might otherwise occur using standardized mix design tables and methods. Furthermore, the methods may allow for re-designing and batching of concrete compositions in a constant and consistent manner.

Another aspect of the disclosure involves the redesigning of one or more pre-existing mix designs used by a manufacturing plant to manufacture its commercial concrete compositions. In one embodiment, the method first involves, as a threshold matter, determining whether and by how much an existing concrete composition is overdesigned. Every concrete composition has a target compressive strength and slump, which is typically determined by the minimum strength and target slump amount that must be guaranteed for that concrete composition, and an actual strength and slump that can be measured by properly preparing concrete under absolute controls based on the mix design and testing its strength and slump.

The extent to which an existing concrete mix design is overdesigned, and thus the amount of raw materials that could be saved as a result of proper designing, can be ascertained by: (1) properly preparing a cementitious composition test sample according to the existing mix design; (2) measuring the actual slump of the cementitious composition; (3) allowing the cementitious composition to harden to a concrete composition; (4) measuring the actual compressive strength of the hardened concrete composition; and (5) comparing the actual strength and slump of the concrete composition with the design strength and slump of the existing mix design. The amount by which the actual strength and slump deviates from the target/design strength and slump corresponds to the degree by which the existing mix design is overdesigned. The foregoing process, which is described more fully in U.S. Pat. Nos. 5,527,387 and 7,386,368, requires an amount of time that is necessary for the concrete composition to cure sufficiently in order to accurately measure actual strength.

The degree of overdesign can alternatively be determined in a more expedited fashion by: (1) determining a water demand of an existing concrete mix design based on the target slump amount and ratio of components within a concrete composition made according to the existing mix design; (2) identifying the relationship between target strength and a water to cement ratio in a mix design with the water demand; and (3) comparing the water to cement ratio of the existing concrete mix design with the water to cement ratio that corresponds to the design slump and strength (i.e., optimize the water to cement ratio). The amount by which the water to cement ratio of the existing design deviates from the optimized water to cement ratio corresponds to the degree by which the existing mix design is overdesigned. Knowledge of how the water to cement ratio varies with concrete strength (i.e., Feret's equation) can therefore be used as a diagnostic tool to determine whether and by how much a pre-existing mix design is overdesigned without waiting for a concrete test sample to harden.

The term “Feret's equation” refers to the following equation, which predicts concrete strength based solely on the volume of hydraulic cement, water and air in the concrete mixture:

σ=K(V_{C}/(V_{C}+V_{W}+V_{A}))²

For purposes of disclosure and the appended claims, the term “Feret's equation” shall also refer to the following modified Feret's equation, which predicts concrete strength based on the volume of hydraulic cement, class F fly ash, water, and air in the concrete mixture:

σ=K(V_{C}+0.3V_{FA}/(V_{C}+0.3V_{FA}+V_{W}+V_{A}))²

As can be seen from this version of Feret's equation, certain types of fly ash contribute to concrete strength but not to the same degree as hydraulic cement. Moreover, although the volume of fly ash is shown multiplied by a fly ash constant 0.3, it may sometimes be appropriate to use a different fly ash constant (e.g., ranging from 0.3-0.6) depending on the type of fly ash used. This substitution can be carried out by those of skill in the art when appropriate, and such modification shall also constitute “Feret's equation”.

In general, the term “Feret's equation” shall refer to other similar variations that may be constructed so long as they at least relate the predicted compressive strength of the concrete composition to the ratio of hydraulic cement volume to cement paste volume (i.e., hydraulic cement, other binders, water and air) in the concrete mixture (e.g., the use of silica fume, which can contribute to strength).

The term “K factor” includes modifications of the exemplary K factors disclosed herein required to convert the calculated strength from English units (i.e., pounds per square inch or “psi”) to metric units (e.g., MPa). As is well-known to those of skill in the art, 1 MPa=145 psi.

It should be appreciated that the K factor is not an absolute number and is not always the same for all different types of concrete compositions and/or apparatus used by manufacturing plants to manufacture concrete. In fact, each manufacturing plant will have its own unique K factor curve depending on the type and quality of aggregates, the type and quality of hydraulic cement used, and the type and quality of mixing apparatus. The K factor curve will typically move up or increase with increasing mixing efficiency, aggregate strength, hydraulic cement strength, and other factors that systematically contribute to concrete strength.

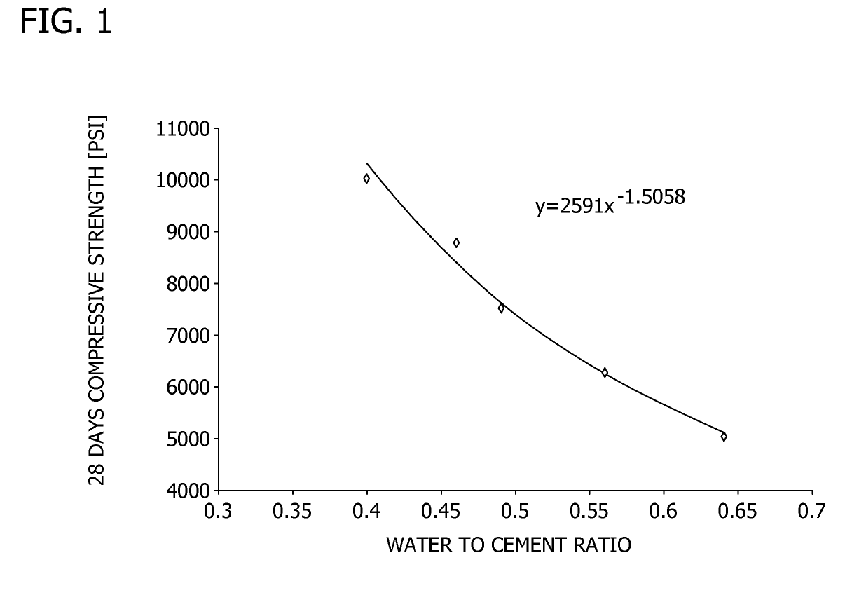

After determining that a pre-existing mix design is overdesigned, an optimized concrete mix design can be designed using the methods of the present disclosure. Generally, the methods of the present disclosure include: (1) preparing at least one saturated-surface-dry cementitious composition having a compressive strength in a target compressive strength range, the saturated-surface-dry cementitious composition being composed of cement, fine aggregate, and coarse aggregate; (2) determining an amount of water to be added to the saturated-surface-dry cementitious composition to produce a target slump amount; (3) preparing at least two initial concrete compositions having the amount of water and the target slump amount; (4) measuring the compressive strength of the initial concrete compositions after a desired time to form a precise strength/water demand fingerprint (see, e.g., FIG. 1); (5) determining an amount of overdesign compressive strength for the initial concrete composition; and (6) determining an optimized water to cement ratio for an overdesigned optimized concrete composition. In one or more embodiments, the methods can further include accurately determining the amount of components in the composition using moisture probes and adjusting for weight inaccuracies as described more fully herein.

As used herein, the term “concrete” refers to a composition that includes a cement paste fraction and an aggregate fraction and is an approximate Bingham fluid.

The terms “aggregate” and “aggregate fraction” refer to the fraction of concrete which is generally non-hydraulically reactive. The aggregate fraction is typically comprised of two or more differently-sized particles, often classified as fine aggregates and coarse aggregates.

As used herein, the terms “fine aggregate” and “fine aggregates” refer to solid particulate materials that pass through a Number 4 sieve (ASTM C125 and ASTM C33).

As used herein, the terms “coarse aggregate” and “coarse aggregates” refer to solid particulate materials that are retained on a Number 4 sieve (ASTM C125 and ASTM C33). Examples of commonly used coarse aggregates include ⅜ inch rock, ¾ inch rock, and 1 inch rock.

As used herein, “optimal” or “optimized” means excellent or highly desirable.

As used herein, “cementitious composition” or “cementitious mix” or “mix design” refers to concrete that has been freshly mixed together and which has not initiated hardening or has not reached initial set. Furthermore, “cementitious composition” refers to the fraction of the concrete composition comprised of water, hydraulic cement, fine aggregate, and coarse aggregate. By contrast, “dry cementitious composition” refers to the fraction of the concrete composition prior to the addition of water; that is, comprised of hydraulic cement, fine aggregate, and coarse aggregate. When blended with appropriate admixtures as disclosed herein, the cementitious composition yields an optimized concrete composition having the functional properties as described below.

As used herein, “saturated-surface-dry cementitious composition” refers to the cementitious composition or mix design including water only within the voids of an aggregate particle filled to the extent achieved by submerging in water for approximately 24 hours (but not including the voids between particles) as defined in ASTM C127 and C128.

As used herein “target strength” or “target compressive strength” refers to the target compressive strength as determined by the individual manufacture. It should be further noted that “strength” and “compressive strength” are used interchangeably to refer to the compressive strength of a concrete composition.

As used herein, the term “segregation” refers to separation of the components of the concrete composition, particularly separation of the cement paste fraction from the aggregate fraction and/or the mortar fraction from the coarse aggregate fraction.

As used herein, the term “bleeding” refers to separation of water from the cement paste.

### Overview of Exemplary Design Optimization Process

Preparing at Least One Saturated-Surface-Dry Cementitious Composition having a Compressive Strength in a Target Compressive Strength Range

Generally, the methods of the present disclosure include first preparing at least one saturated-surface-dry cementitious composition having a compressive strength in a target compressive strength range. Typically, the saturated-surface-dry cementitious composition includes cement, fine aggregate, and coarse aggregate.

A. Cement, Fine Aggregate, and CoarseAggregate

Hydraulic cements, also referred to herein as cements, are materials that can set and harden in the presence of water. The cement can be a Portland cement, modified Portland cement, or masonry cement. For purposes of this disclosure, Portland cement includes all cementitious compositions which have a high content of tricalcium silicate, including Portland cement, cements that are chemically similar or analogous to Portland cement, and cements that fall within ASTM specification C-150-00. Portland cement, as used in the trade, means a hydraulic cement produced by pulverizing clinker, comprising hydraulic calcium silicates, calcium aluminates, and calcium aluminoferrites, and usually containing one or more forms of calcium sulfate as an interground addition. Portland cements are classified in ASTM C 150 as Type I II, III, IV, and V. Other hydraulically settable materials include ground granulated blast-furnace slag, hydraulic hydrated lime, white cement, slag cement, calcium aluminate cement, silicate cement, phosphate cement, high-alumina cement, magnesium oxychloride cement, oil well cements (e.g., Type VI, VII and VIII), and combinations of these and other similar materials.

Pozzolanic materials such as slag, class F fly ash, class C fly ash, silica fume, and other siliconeous materials can also be considered to be hydraulically settable materials (also referred to herein in combination with cement as cementitious materials) when used in combination with conventional hydraulic cements, such as Portland cement. A pozzolan is a siliceous or aluminosiliceous material that possesses cementitious value and will, in the presence of water and in finely divided form, chemically react with calcium hydroxide produced during the hydration of Portland cement to form hydratable species with cementitious properties. Diatomaceous earth, opaline, cherts, clays, shales, fly ash, silica fume, volcanic tuffs, pumices, and trasses are some of the known pozzolans. Certain ground granulated blast-furnace slags and high calcium fly ashes possess both pozzolanic and cementitious properties. Fly ash is defined in ASTM C618.

Aggregates are included in the saturated-surface-dry cementitious composition to add bulk and to give the initial concrete composition its target strength properties. The aggregate includes both fine aggregate and coarse aggregate. Examples of suitable materials for coarse and/or fine aggregates include silica, quartz, crushed round marble, glass spheres, granite, limestone, bauxite, calcite, feldspar, alluvial sands, or any other durable aggregate, and mixtures thereof. In a preferred embodiment, the fine aggregate consists essentially of “sand” and the coarse aggregate consists essentially of “rock” (e.g., ⅜ inch and/or ¾ inch rock) as those terms are understood by those of skill in the art. In one aspect, the saturated-surface-dry cementitious composition (and the initial concrete composition) includes at least two separate sizes of coarse aggregate.

It should be recognized, that while discussed herein as using two sizes of coarse aggregate, the saturated-surface-dry cementitious composition may be produced with either solely the less coarse or solely the more coarse aggregate without departing from the present disclosure.

The amounts of the above components of the saturated-surface-dry cementitious composition can be any suitable amounts for making the saturated-surface-dry cementitious composition which can be hydrated to form a concrete composition. Generally, the amounts will be determined using a specific manufacturer's typical mix designs. Accordingly, the methods of the present disclosure can be individualized depending upon the manufacturer and its desired or target properties for the concrete composition.

Once a general mix design has been determined, the design is further optimized so as to produce a saturated-surface-dry cementitious composition that can produce a compressive strength in a target compressive strength range. As defined above, the “target compressive strength range” is any compressive strength range as targeted by the specific manufacture. Typically, the target compressive strength range can include any compressive strength from about 2000 psi to about 16000 psi.

Furthermore, in one or more preferred embodiments, along with the existing mix designs, the manufacturer provides a characterization of one or more components of the mix. More particularly, the manufacture provides a manufacturer's supply material statement, which can include characterizations of properties such as, for example, a sieve analysis, specific gravity of the fine aggregate, specific gravity of the coarse aggregate, absorption of the fine aggregate, absorption of the coarse aggregate, maximum particle packing density, and the water to hydraulic cement ratio typically used in the designed, and the like, and combinations thereof.

As well known in the art, specific gravity of the fine and coarse aggregates can be provided as surface-saturated-dry specific gravity; bulk specific gravity; and actual specific gravity under standard ASTM methods. As the surface-saturated-dry specific gravity measures specific gravity (ASTM C127 and C128) when the surface of the aggregate is dry and any available water is absorbed through the pores of the fine and coarse aggregate, there is no effect on strength. Accordingly, to determine excess water in a mix design, the manufacture's supply material statement desirably includes the surface-saturated-dry specific gravity for the fine aggregate, the surface-saturated-dry specific gravity for the coarse aggregate, absorption for the fine aggregate, absorption for the coarse aggregate, and combinations thereof.

Many times the manufacture's supply material statement is not sufficiently accurate. For example, as water is being absorbed through the pores of the fine and coarse aggregate, even when the aggregates appear dry, there is free water still available on the aggregates. As used herein, “free water” refers to any water that is in addition to the water absorbed through the pores of the fine and coarse aggregate, typically water resulting from delivery, weather conditions, and storage conditions. Free water can only be determined using moisture probes and similar equipment that measures total moisture:free moisture (i.e., total moisture minus absorption). Many times the supply material statement provided by the manufacture fails to consider the free water, thereby skewing the characterization of the fine and coarse aggregates. In other cases, the manufacture may not even have a supply material statement.

Accordingly, to more accurately characterize at least one or more components, in some embodiments, the methods desirably further include introducing at least one moisture probe into a fine aggregate hopper and at least one moisture probe into a coarse aggregate hopper to measure the free water available in the fine and coarse aggregate used to prepare the saturated-surface-dry cementitious composition. Typically, these probes are either based on di-electric measurements or microwave measurements. Particularly suitable moisture probes for use in the hoppers include those commercially available as Hydro-Probe II or Hydro-Control V from Hydronix (United Kingdom). Other probes are commercially available from Liebherr or Eirich (Germany).

Moreover, in many cases, to confirm the characterization of the components of the saturated-surface-dry cementitious composition, the method includes preparing a test sample of the saturated-surface-dry cementitious composition and comparing the sample to the characterizations received in the manufacture's supply material statements.

Once an accurate characterization is obtained and mix designs are made according to the manufacturer's desired target compressive strength range, the ratio of fine aggregate to coarse aggregated in the dry cementitious composition is adjusted for optimal workability. Typically, the ratio is adjusted according to the desired target compressive strength range. For example, when the target compressive strength range is 8000 psi or greater, the ratio of fine aggregate to coarse aggregate is adjusted to about 50:50. By contrast, when the target compressive strength range is less than 8000 psi, the ratio of fine aggregate to coarse aggregate is adjusted to about 55:45.

At least one test saturated-surface-dry cementitious composition is then prepared. In one or more preferred embodiments, a plurality of test saturated-surface-dry cementitious compositions is prepared. All of the saturated-surface-dry cementitious compositions prepared will have compressive strengths within the target compressive strength ranges as described above.

### Determining an Amount of Water to Be Added To the Saturated-Surface-Dry Cementitious Composition for a Target Slump Amount

Water is added to the saturated-surface-dry cementitious compositions to form the test sample concrete compositions. Initially water is added according to a water content determined by the manufacturer's existing mix designs to produce a target slump amount of 2 inches. Typically, either a fingerprint curve is used from a previous customer or a series of increasing water to cement ratios that is known from experience to provide strengths in the targeted range are chosen. A 2-inch slump is generally chosen as it is desirable to keep the slump as low as possible because lower water demand requires less cement for all water-to-cement ratios, reducing costs, and further because the slump is easily measured. Additionally, by requiring the slump to be above 0, the amount of plasticizer required for the final slump is reduced which guarantees adequate cohesion of the cement at higher dosage rates.

If needed, water is then slowly and continuously added to the saturated-surface-dry cementitious compositions until the actual target slump amount of 2 inches is achieved. Generally, slump is commonly used as the measure of concrete workability, e.g., as measured using ASTM-C143, and increasing the slump is understood to require less energy to position and finish the concrete.

In cases in which the initial amount of water added, according to the pre-designed water to cement ratio, produces a slump that is greater than desired, the amount of water required to achieve the target slump amount can be determined using formula (I):

$${W}_{2} = \frac{{W}_{1}}{{( {S}_{1} \text{/} {S}_{2} )}^{0.085}} \qquad ( I )$$

W₂ is the amount of water necessary for obtaining the target slump amount. W₁ is the amount of water that has been added to the saturated-surface-dry cementitious composition. S₁ is the current slump of the saturated-surface-dry cementitious composition with the water added, and S₂ is the target slump amount.

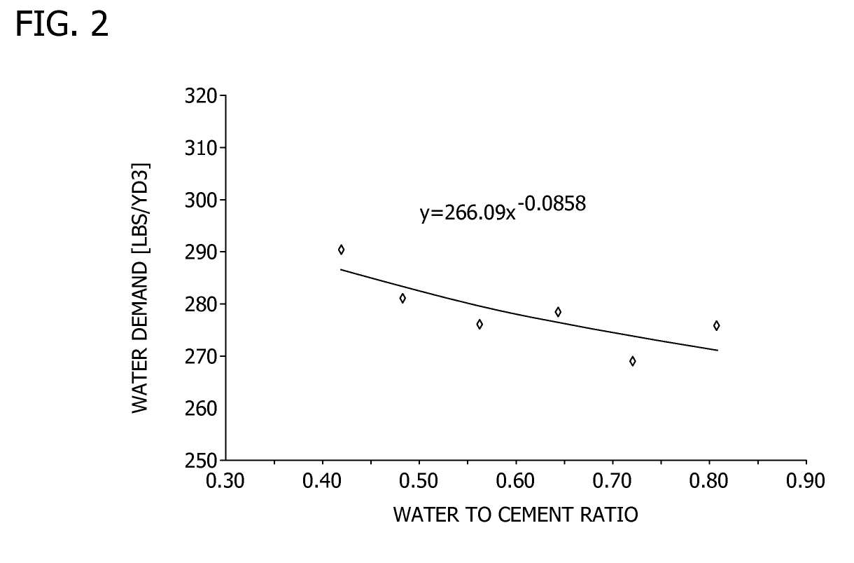

Alternatively, if a plurality of saturated-surface-dry cementitious compositions is prepared for testing, the plurality of saturated-surface-dry cementitious compositions can have water continuously added to determine the amount of water to be added to each composition for producing the target slump amount. Once the amount of water has been determined for the plurality of saturated-surface-dry cementitious compositions, the amount of water (i.e., water demand) for each of the compositions can be plotted according to their water to cement ratio. Specifically, as shown in one embodiment (see FIG. 2), it is seen that water demand decreases for a 2-inch slump as the water to cement ratio increases and follows a logarithmic curve. From the curve, water demand for compositions having varying water to cement ratios can be determined. Alternatively, the first batch mix to determine the water demand for a 2-inch slump can be tested in a laboratory and be determined by adding water until the slump is achieved and measuring the amount of added water, as described above.

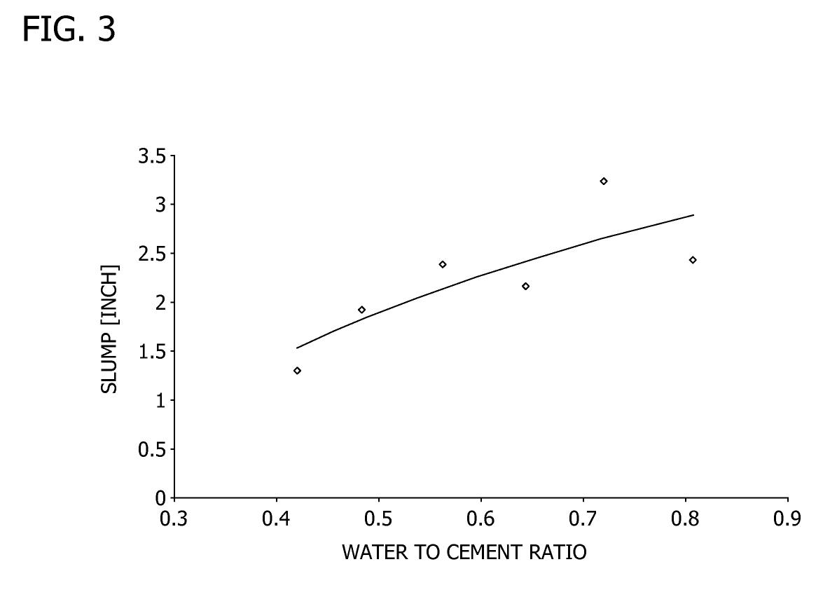

Additionally, once the amount of water to be added to a saturated-surface-dry cementitious composition is determined, initial concrete compositions can be designed using the amount of water for the particular target slump amount. Furthermore, the target slump amount can be predicted using the water to cement ratio of the mix with water added thereto. Specifically, slump can be predicted by plotting slump versus the water to cement ratio with the desired water amount (see FIG. 3). This is beneficial for future designing of mixes and compositions for the manufacture and/or for new customers/manufacturers.

Preparing an Initial Concrete Composition with the Amount of Water

After the amount of water is determined for adding to the saturated-surface-dry cementitious composition for achieving the target slump amount, the initial cement composition having the amount of water added is cast.

Typically, while at least two initial concrete compositions are prepared, more than two compositions, such as three or more compositions, can be prepared to further analyze strength more precisely. For example, in one embodiment, 2-6 setup mixes (i.e., initial cement compositions) are typically chosen from previous customer data or randomly chosen in the desired water to cement ratio corresponding to the target strength range, as described above. While more precision can be confirmed using more compositions, by preparing only two compositions, costs and time needed for analysis can be reduced.

In one or more embodiments of the present disclosure, the amount of water can be limited to provide a slump within the range of about 1 inch to about 3 inches, and the method can further include adding one or more plasticizers to achieve the target slump amount.

Exemplary plasticizers (also referred to herein as dispersants) are typically used in concrete compositions to increase flowability without adding water. Dispersants can be used to lower the water content in the concrete composition to increase strength and/or obtain higher slump without adding additional water. A dispersant, if used, can be any suitable dispersant such as lignosulfonates, beta naphthalene sulfonates, sulfonated melamine formaldehyde condensates, polyaspartates, polycarboxylates with and without polyether units, naphthalene sulfonate formaldehyde condensate resins, or oligomeric dispersants. Depending on the type of dispersant, the dispersant may be characterized as a high range water reducer, fluidizer, antiflocculating agent, and/or superplasticizer.

One class of dispersants includes mid-range water reducers. These dispersants are often used to improve the finishability of concrete flatwork. Mid-range water reducers should at least meet the requirements for Type A in ASTM C 494.

Another class of dispersants includes high range water-reducers (HRWR). These dispersants are capable of reducing water content of a given fresh concrete mix by as much as 10% to 45%. HRWRs can be used to increase strength or to greatly increase the slump to produce a “flowing” concrete composition without adding additional water. HRWRs that can be used in the present disclosure include those covered by ASTM C 494 and types F and G, and Types 1 and 2 in ASTM C 1017. Examples of HRWRS are described in U.S. Pat. No. 6,858,074.

### Measuring the Compressive Strength of the Initial Concrete Compositions

Once prepared, the initial setup concrete compositions are then allowed to set and harden for a desired time period, such as 1, 3, 7, 14, 28, 56, and/or 90 days. Desirably, in one or more embodiments, the compressive strength of the initial concrete composition is measured after 28 days. Typically, compressive strength is measured using ASTM C139.

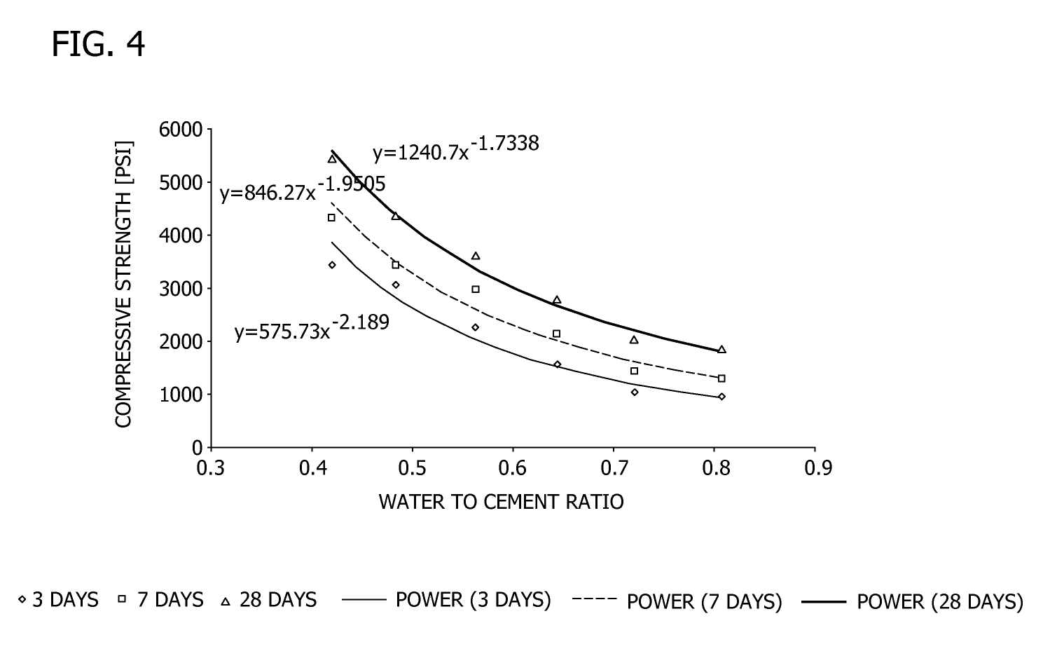

It has been found that the compressive strengths of the initial concrete compositions decrease as the water to cement ratio increases and follows a logarithmic curve in the form of y=A×(W/C)^{-B} (also referred to herein as a strength to water:cement fingerprint). It has been found that the values for constants “A” and “B” are specific for a particular plant and are specific for a particular concrete composition; that is, when a plant chooses to use cement, and pozzolans (if any) from a specific supplier, and sand and aggregates from a specific source, a fingerprint curve results that is very specific for the chosen materials and the particular plant. In one embodiment, this has been found true for the compressive strengths after 3, 7, 21, and 28 days, although, there is a more gradual decrease in the 3- and 7-day strength measurements as compared to the 28-day measurement. For example, in FIG. 4, the compressive strength is measured with compositions having water to cement ratios ranging from about 0.4 to about 0.8. From the curve, compressive strength for compositions having varying water to cement ratios other than shown can be predicted. This can be beneficial for future use in designing mixes and cementitious compositions for the manufacturer and/or for new customers/manufacturers.

Additionally, by generating a controlled and precise “fingerprint” curve for strength in relation to water to cement ratio, the compressive strength of a particular composition at 28 days can be predicted using the strengths measured at 3 days or 7 days, and vice versa. This can be beneficial for determining the compressive strengths of compositions without having to wait the full 28 days for the composition to set and hardened, and further, can be beneficial for future designing of mixes and cementitious compositions for the manufacturer and/or for new customers/manufacturers.

### Determining Amount of Overdesign

As noted above, manufacturers conventionally overdesign their mixes and compositions to ensure adequate functional properties such as strength. Accordingly, the method of the present disclosure further includes determining an amount of overdesign needed to generate an adequate overdesign compressive strength for the initial concrete compositions.

The amount of overdesign compressive strength typically ranges from about 10% to about 30% greater than a target compressive strength for the initial concrete composition after the desired time (typically, 28 days). As used herein, “target compressive strength” refers to the target compressive strength for the concrete composition sold to the consumer. More suitably, the overdesign compressive strength is about 10% to about 25% greater than the target compressive strength of the initial concrete composition after the desired time, and even more suitably, about 10% greater than the target compressive strength of the initial concrete composition after the desired time.

By determining the amount of overdesign compressive strength required for the initial concrete composition, the optimized water to cement ratio for an overdesigned optimized concrete composition can be determined. Specifically, the above-described logarithmic curve (or equation from the curve), plotting compressive strength versus water to cement ratio is used to predict the optimized water to cement ratio needed for the overdesigned optimized concrete composition.

It should be recognized that even with the overdesigning of the optimized concrete composition, costs and materials are reduced during production. Specifically, as the water to cement ratio has been optimized, and particularly, the amount of water and cement has been minimized to produce the target slump amount and target compressive strength, excess cement is not wasted for compensating for the excess water. Furthermore, the compressive strength is optimized without having to constantly alternate the addition of water and cement or water and aggregate into the composition to ensure that the concrete composition will not fail in the field.

Furthermore, it should be recognized that once a mix design has been optimized for a manufacturer using the methods described above, and the constituent components for the compositions are the same, additional mixes and concrete compositions can be made and modified to provide various slumps and strengths without making test samples. Specifically, as noted above, the water to cement ratios can be adjusted for various other desired or target strength ranges and slumps by using the logarithmic curves discussed above; that is, following determination of the precise fingerprint curve all concrete designs in a given plant can be determined based on: water demand, and “A”, and “B” from the logarithmic curve. From the constants “A” and “B,” the required water to cement ratio for a target compressive strength can be calculated and the water demand indicates the necessary water required for a 2-inch slump. Accordingly, mixes for the manufacture can be easily reproduced and optimized, and further, these mixes can be used as starting mixes for new customers/manufacturers.

### Providing the Concrete Composition

In another embodiment of the present disclosure, once the optimized water to cement ratio for an overdesigned optimized concrete composition is determined it may be provided. In some embodiments, the term “provided” or “providing” means that the water to cement ratio and/or any other information calculated or determined is: (1) provided for storage in, for example, a computer memory designed for storage of data; (2) provided for display on, for example, a screen such as an liquid crystal display (LCD) screen or touch screen; and/or (3) provided to a technician, operator, engineer or other person for the purpose of making or otherwise using the concrete composition.

### Admixtures and Fillers

In one or more preferred embodiments, once the overdesigned optimized concrete composition is designed, the mix can be altered to include a wide variety of admixtures and fillers to give the initial concrete composition, and thus the overdesigned optimized concrete composition, various desired or targeted properties. Examples of admixtures that can be used in the compositions include, but are not limited to, air entraining agents, strength enhancing amines and other strengtheners, dispersants, water reducers, superplasticizers, water binding agents, rheology-modifying agents, viscosity modifiers, corrosion inhibitors, pigments, wetting agents, water soluble polymers, water repellents, strengthening fibers, permeability reducers, pumping aids, fungicidal admixtures, germicidal admixtures, insecticidal admixtures, finely divided mineral admixtures, alkali reactivity reducer, bonding admixtures, and mixtures thereof.

Air-entraining agents are compounds that entrain microscopic air bubbles in freshly mixed concrete compositions (i.e., initial and/or overdesigned optimized concrete compositions), which then harden into concrete (e.g., hardened optimized concrete compositions) having microscopic air voids. Entrained air dramatically improves the durability of concrete exposed to moisture during freeze thaw cycles and greatly improves resistance to surface scaling caused by chemical deicers. Air-entraining agents can also reduce the surface tension of a composition at low concentration. Air entrainment can also increase the workability of compositions and reduce segregation and bleeding. Examples of suitable air-entraining agents include wood resin, sulfonated lignin, petroleum acids, proteinaceous material, fatty acids, resinous acids, alkylbenzene sulfonates, sulfonated hydrocarbons, vinsol resin, anionic surfactants, cationic surfactants, nonionic surfactants, natural rosin, synthetic rosin, inorganic air entrainers, synthetic detergents, the corresponding salts of these compounds, and mixtures of these compounds. Air-entraining agents are added in an amount to yield a desired level of air in a fresh concrete mix. Generally, the amount of air entraining agent in a composition ranges from about 0.2 to about 6 fluid ounces per hundred pounds of dry cement. Weight percentages of the primary active ingredient of the air-entraining agents (i.e., the compound that provides the air entrainment) are about 0.001% to about 0.1%, based on the weight of concrete composition. The particular amount used will depend on materials, mix proportion, temperature, and mixing action.

In yet another alternative embodiment, the overdesigned optimized concrete composition does not include any air entraining agent but rather a greater quantity of superplasticizer, as discussed herein.

Strength enhancing amines are compounds that improve the compressive strength of concrete made from hydraulic cement mixes (e.g., Portland cement concrete compositions). The strength enhancing amine includes one or more compounds from the group selected from poly(hydroxyalkylated)polyethyleneamines,

poly(hydroxyalkylated)poly-ethylenepolyamines, poly(hydroxyalkylated)polyethyleneimines, poly(hydroxyl-alkylated)polyamines, hydrazines, 1,2-diaminopropane, polyglycoldiamine, poly-(hydroxylalkyl)amines, and mixtures thereof. An exemplary strength enhancing amine is 2,2,2,2 tetra-hydroxydiethylenediamine.

Viscosity modifying agents (VMA), also known as rheological modifiers or rheology modifying agents, can be added to the concrete composition produced in the present disclosure. These additives are usually water-soluble polymers and function by increasing the apparent viscosity of the mix water. This enhanced viscosity facilitates uniform flow of the particles and reduces bleed, or free water formation, on the fresh paste surface.

Suitable viscosity modifying agents that can be used in the present disclosure include, for example, cellulose ethers (e.g., methylcellulose, hydroxyethylcellulose, hydroxypropylmethylcellulose, carboxymethylcellulose, carboxymethylhydroxyethyl cellulose, methylhydroxyethylcellulose, hydroxymethylethylcellulose, ethylcellulose, hydroxyethylpropylcellulose, and the like); starches (e.g., amylopectin, amylose, seagel, starch acetates, starch hydroxy-ethyl ethers, ionic starches, long-chain alkylstarches, dextrins, amine starches, phosphates starches, and dialdehyde starches); proteins (e.g., zein, collagen and casein); synthetic polymers (e.g., polyvinylpyrrolidone, polyvinylmethyl ether, polyvinyl acrylic acids, polyvinyl acrylic acid salts, polyacrylimides, ethylene oxide polymers, polylactic acid polyacrylates, polyvinyl alcohol, polyethylene glycol, and the like); exopolysaccharides (also known as biopolymers, e.g., welan gum, xanthan, rhamsan, gellan, dextran, pullulan, curdlan, and the like); marine gums (e.g., algin, agar, seagel, carrageenan, and the like); plant exudates (e.g., locust bean, gum arabic, gum karaya, tragacanth, ghatti, and the like); seed gums (e.g., guar, locust bean, okra, psyllium, mesquite, and the like); starch-based gums (e.g., ethers, esters, and related derivatized compounds). See, for example, Shandra, Satish and Ohama, Yoshihiko, “Polymers In Concrete”, published by CRC press, Boca Ration, Ann Harbor, London, Tokyo (1994).

Viscosity modifying agents are typically used with water reducers in highly flowable mixtures to hold the fresh concrete mix and concrete composition together. Viscosity modifiers can disperse and/or suspend components of the composition thereby assisting in holding the composition together.

Corrosion inhibitors in initial concrete compositions (and overdesigned optimized concrete compositions) serve to protect embedded reinforcing steel from corrosion due to its highly alkaline nature. The highly alkaline nature of the concrete composition causes a passive and non-corroding protective oxide film to form on the steel. However, carbonation or the presence of chloride ions from deicers or seawater can destroy or penetrate the film and result in corrosion. Corrosion-inhibiting admixtures chemically arrest this corrosion reaction. Examples of materials used to inhibit corrosion include calcium nitrite, sodium nitrite, sodium benzoate, certain phosphates or fluorosilicates, fluoroaluminates, amines, organic based water repelling agents, and related chemicals.

Dampproofing admixtures reduce the permeability of concrete composition that have low cement contents, high water-cement ratios, or a deficiency of fines in the aggregate. These admixtures retard moisture penetration into dry concrete and include certain soaps, stearates, and petroleum products.

Permeability reducers are used to reduce the rate at which water under pressure is transmitted through the concrete composition. Silica fume, fly ash, ground slag, natural pozzolans, water reducers, and latex can be employed to decrease the permeability of the concrete composition.

Pumping aids are added to concrete compositions to improve pumpability. These admixtures thicken the fluid concrete, i.e., increase its viscosity, to reduce de-watering of the paste while it is under pressure from the pump. Among the materials used as pumping aids in fresh concrete mixes are organic and synthetic polymers, hydroxyethylcellulose (HEC) or HEC blended with dispersants, organic flocculents, organic emulsions of paraffin, coal tar, asphalt, acrylics, bentonite and pyrogenic silicas, natural pozzolans, fly ash and hydrated lime.

Other additives can include accelerating agents and retarding agents. An accelerating agent is added to a concrete composition to initiate hardening of the composition. Accelerating agents, also referred to as accelerators, are admixtures that increase the rate of cement hydration. Examples of accelerators include, but are not limited to, nitrates of alkali metals, alkaline earth metals, or aluminum; nitrites of alkali metals, alkaline earth metals, or aluminum; thiocyanates of alkali metals, alkaline earth metals, or aluminum; thiosulphates of alkali metals, alkaline earth metals, or aluminum; hydroxides of alkali metals, alkaline earth metals, or aluminum; carboxylic acid salts of alkali metals, alkaline earth metals, or aluminum (such as calcium formate); and halide salts (such as bromides) of alkali metals or alkaline earth metals. One particularly preferred accelerating agent to be used in the concrete composition includes Pozzolith® NC534, commercially available from BASF, The Chemical Company, Cleveland, Ohio.

Retarding agents, also known as retarders, delayed-setting or hydration control admixtures, are used to retard, delay, or slow the rate of cement hydration. They can be added to the initial concrete composition upon initial batching or sometime after the hydration process has begun. Examples of retarding agents include lignosulfonates and salts thereof, hydroxylated carboxylic acids, borax, gluconic acid, tartaric acid, mucic acid, and other organic acids and their corresponding salts, phosphonates, monosaccharides, disaccharides, trisaccharides, polysaccharides, certain other carbohydrates such as sugars and sugar-acids, starch and derivatives thereof, cellulose and derivatives thereof, water-soluble salts of boric acid, water-soluble silicone compounds, sugar-acids, and mixtures thereof. Exemplary retarding agents are commercially available under the tradename Delvo®, from Masterbuilders (a division of BASF, The Chemical Company, Cleveland, Ohio).

Bacteria and fungal growth on or in hardened concrete compositions may be partially controlled through the use of fungicidal, germicidal, and insecticidal admixtures. Examples of such materials include polyhalogenated phenols, dialdrin emulsions, and copper compounds.

Fibers can be distributed throughout a concrete composition to strengthen it. Upon hardening, this concrete composition is referred to as fiber-reinforced concrete. Fibers can be made of zirconium materials, carbon, steel, fiberglass, or synthetic polymeric materials, e.g., polyvinyl alcohol (PVA), polypropylene (PP), nylon, polyethylene (PE), polyester, rayon, high-strength aramid (e.g., p- or m-aramid), or mixtures thereof.

Shrinkage reducing agents include but are not limited to alkali metal sulfate, alkaline earth metal sulfates, alkaline earth oxides, e.g., sodium sulfate and calcium oxide.

Finely divided mineral admixtures are materials in powder or pulverized form added to compositions before or during the mixing process to improve or change some of the plastic or hardened properties of Portland cement concrete. The finely divided mineral admixtures can be classified according to their chemical or physical properties as: cementitious materials; pozzolans; pozzolanic and cementitious materials; and nominally inert materials. Nominally inert materials include finely divided raw quartz, dolomites, limestones, marble, granite, and others.

Alkali-reactivity reducers can reduce the alkali-aggregate reaction and limit the disruptive expansion forces in hardened concrete. Pozzolans (fly ash and silica fume), blast-furnace slag, salts of lithium, and barium are especially effective.

Bonding admixtures are usually added to hydraulic cement mixtures to increase the bond strength between old and new concrete and include organic materials such as rubber, polyvinyl chloride, polyvinyl acetate, acrylics, styrene-butadiene copolymers, and powdered polymers.

Natural and synthetic admixtures are used to color concrete compositions for aesthetic and safety reasons. Coloring admixtures are usually composed of pigments and include carbon black, iron oxide, phthalocyanine, umber, chromium oxide, titanium oxide and cobalt blue.

### Exemplary Operating Environment

A computer, computer system, and/or computing device such as described herein has one or more processors or processing units, system memory, and some form of computer readable media. By way of example and not limitation, computer readable media include computer storage media and communication media. Computer storage media include volatile and nonvolatile, removable and non-removable media implemented in any method or technology for storage of information such as computer readable instructions, data structures, program modules or other data. Communication media typically embody computer readable instructions, data structures, program modules, or other data in a modulated data signal such as a carrier wave or other transport mechanism and include any information delivery media. Combinations of any of the above are also included within the scope of computer readable media.

The computer may operate in a networked environment using logical connections to one or more remote computers, such as a remote computer or hand-held device. Although described in connection with an exemplary computing system environment, embodiments of the disclosure are operational with numerous other general purpose or special purpose computing system environments or configurations. The computing system environment is not intended to suggest any limitation as to the scope of use or functionality of any aspect of the disclosure. Moreover, the computing system environment should not be interpreted as having any dependency or requirement relating to any one or combination of components illustrated in the exemplary operating environment. Examples of well known computing systems, environments, and/or configurations that may be suitable for use with aspects of the disclosure include, but are not limited to, personal computers, server computers, hand-held or laptop devices, multiprocessor systems, microprocessor-based systems, set top boxes, programmable consumer electronics, mobile telephones, network PCs, minicomputers, mainframe computers, distributed computing environments that include any of the above systems or devices, and the like.

Embodiments of the disclosure may be described in the general context of computer-executable instructions, such as program modules, executed by one or more computers or other devices. The computer-executable instructions may be organized into one or more computer-executable components or modules. Generally, program modules include, but are not limited to, routines, programs, objects, components, and data structures that perform particular tasks or implement particular abstract data types. Aspects of the disclosure may be implemented with any number and organization of such components or modules. For example, aspects of the disclosure are not limited to the specific computer-executable instructions or the specific components or modules illustrated in the figures and described herein. Other embodiments of the disclosure may include different computer-executable instructions or components having more or less functionality than illustrated and described herein. Aspects of the disclosure may also be practiced in distributed computing environments where tasks are performed by remote processing devices that are linked through a communications network. In a distributed computing environment, program modules may be located in both local and remote computer storage media including memory storage devices.

The embodiments illustrated and described herein as well as embodiments not specifically described herein but within the scope of aspects of the disclosure constitute exemplary means for making various concretes.

The order of execution or performance of the operations in embodiments of the disclosure illustrated and described herein is not essential, unless otherwise specified. That is, the operations may be performed in any order, unless otherwise specified, and embodiments of the disclosure may include additional or fewer operations than those disclosed herein. For example, it is contemplated that executing or performing a particular operation before, contemporaneously with, or after another operation is within the scope of aspects of the disclosure.

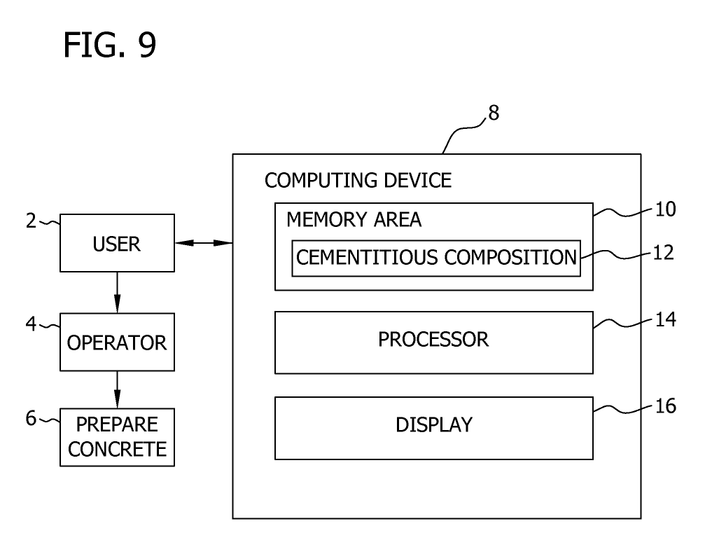

Referring now to FIG. 9, there is shown a system diagram of one embodiment of the present disclosure, including a user 2 in communication with a computing device 8 including a memory area 10, a processor 14 and a display 16. The memory area 10 includes cementitious composition information 12. The user 2 is also shown in communication with an operator 4 who may prepare concrete 6.

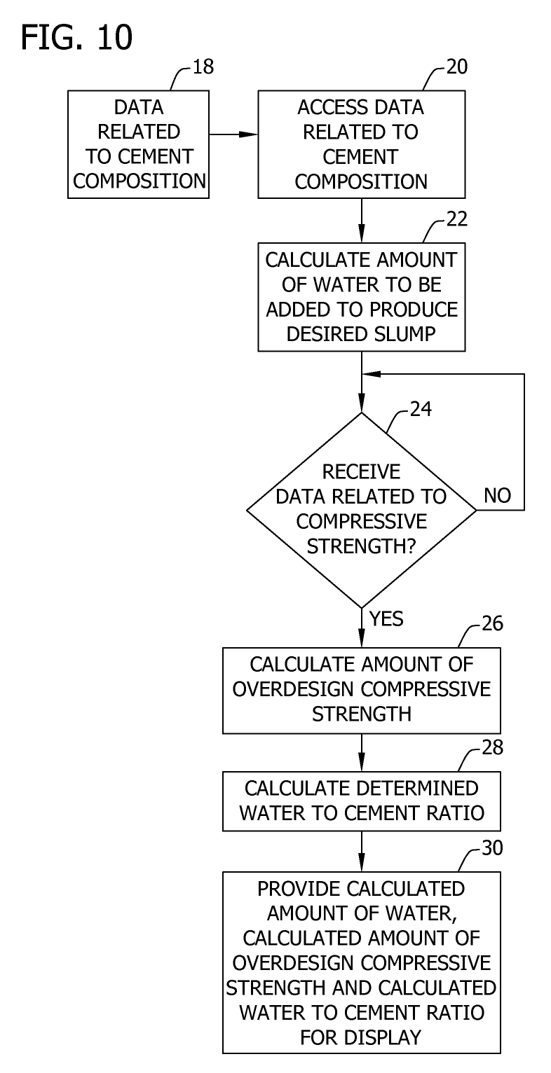

Referring now to FIG. 10, there is shown a flow chart showing one embodiment of the present disclosure including accessing data 20 related to a cement composition 18 and then calculating an amount of water to be added to produce a target slump 22, receiving data related to compressive strength 24, calculating an amount of overdesign compressive strength 26, calculating an optimized water to cement ratio 28 and then providing the calculated amount of water, calculated amount of overdesign compressive strength and calculated water to cement ratio for display 30.

Having described the disclosure in detail, it will be apparent that modifications and variations are possible without departing from the scope of the disclosure defined in the appended claims.

### EXAMPLE

The following non-limiting example is provided to further illustrate the present disclosure.

### Example 1

In this Example, a concrete design mix was optimized to yield target compressive strength and a target slump amount with a minimal amount of water and cement. More particularly, six setup mix designs were designed and the water to cement ratios were determined for producing strengths and slumps in the desired or targeted range (e.g., 3,000 psi, 4,000 psi, 5,000 psi, and 6,000 psi).

To begin, an existing manufacturer provided a manufacturer's material supply statement that included a cement data sheet, a sieve analysis, and surface-saturated-dry specific gravity and absorption data for both sand and rock aggregates. Six sample mixes were then designed using the manufacturer's mix designs corresponding to more than 80% of their sales volume and using representing water content (i.e., the present amount of water used by manufacturer) and water to cement ratios to cover the target range of strengths. In this case, water contents of: 258, 254, 254, 250, 238, and 265 were chosen, and water-to-cement ratios of: 0.737, 0.651, 0.568, 0.496, 0.399, and 0.379 were chosen. Specifically, the six setup mix designs were chosen to generate a curve ranging in compressive strength of from about 3000 psi to about 6000 psi. Prior to making the mixes, moisture probes were installed into the fine aggregate hopper and the coarse aggregate hopper to allow for accurate measurements of the moisture content in the fine and coarse aggregate components and the weighing accuracy of all components were fine-tuned to be in compliance with ASTM C94. The six mix designs are shown in Table 1.

TABLE 1
Initial Set-up Mix Designs
Setup Mix Designs, SSD: (Surface-Saturated-Dry)

| | Mix 1 | Mix 2 | Mix 3 | Mix 4 | Mix 5 | Mix 6 |
|---|---|---|---|---|---|---|
| Cement (lbs/yd³) | 350 | 390 | 447 | 504 | 598 | 701 |
| Sand (lbs/yd³) | 1717 | 1747 | 1706 | 1644 | 1567 | 1441 |
| Rock (lbs/yd³) | 1421 | 1411 | 1390 | 1373 | 1353 | 1283 |
| Water (lbs/yd³) | 258 | 254 | 254 | 250 | 238 | 265 |
| Air-entrained Agent | 2 | 2 | 2 | 2 | 2 | 2 |
| (AEA) (fl. oz./yd³) | | | | | | |
| Air (vol. %) | 5 | 5 | 5 | 5 | 5 | 5 |
| w/c | 0.737 | 0.651 | 0.568 | 0.496 | 0.399 | 0.379 |
| (Water to hydraulic | | | | | | |
| cement ratio) | | | | | | |

Once designed, the mixes are individual prepared by entering the mix designs into the plant batch computer and batching the mixes without adding plasticizer or additional admixtures into the concrete truck in a volume of 4 yd³ (approximately 4-10 yd³).

Following initial mixing at a speed of approximately 10 revolutions per minute as is directed by ASTM C94 for approximately 2-4 minutes, water was added to the truck until a slump of approximately 2″ is observed. The slump can be determined either by judgment by a trained eye or by discharging a small volume of concrete that gets tested with a slump cone. The amount of water added per cubic yard is noted and used to calculate the actual total amount of water added per cubic yard. Following, a high range water reducer (HRWR) is added until the target slump amount is achieved, and the slump and air content are measured and cylinders are cast for determination of 3-, 7- and 28-day compressive strength.

Additional water had to be added to each of the six mixes listed in Table 1 to obtain a 2″ slump in the respective amounts of: 17, 15, 24, 26, 43 and 25 lbs per cubic yard. After re-calculating the tested mixes to a volume of 1 yd³, the design mixes looked as shown in Table 2. The re-calculated water demand for the six setup mixes for a 2″ slump (i.e., water demand) is shown in FIG. 2 and can be described by the equation in Formula (II):

Water Demand=266.09×w/c^{-0.0858} (II)

TABLE 2
Set-up Mix Designs After Adding Water and Plasticizer
Set-up Mix Designs, SSD, after adding water and plasticizer

| | Mix 1 | Mix 2 | Mix 3 | Mix 4 | Mix 5 | Mix 6 |
|---|---|---|---|---|---|---|
| Cement | 341 | 373 | 433 | 490 | 582 | 692 |
| (lbs/yd³) | | | | | | |
| Sand | 1712 | 1651 | 1644 | 1634 | 1611 | 1551 |
| (lbs/yd³) | | | | | | |
| Rock | 1401 | 1364 | 1359 | 1350 | 1332 | 1281 |
| (lbs/yd³) | | | | | | |
| Water | 276 | 269 | 278 | 276 | 281 | 291 |
| (lbs/yd³) | | | | | | |
| AEA (fl. | 2.0 | 2.5 | 2.0 | 2.0 | 2.0 | 2.0 |
| oz./yd³) | | | | | | |
| HRWR | 38.7 | 44.8 | 47.8 | 47.5 | 45.7 | 40.3 |
| (fl. | | | | | | |
| oz./yd³) | | | | | | |
| Air | 6.8 | 8.4 | 7.0 | 6.5 | 5.4 | 5.3 |
| (vol. %) | | | | | | |
| Slump | 8.1 | 8.2 | 8.1 | 8.5 | 9.0 | 8.9 |
| (inch) | | | | | | |
| Final w/c | 0.81 | 0.72 | 0.64 | 0.56 | 0.48 | 0.42 |
| Starting | 0.74 | 0.65 | 0.57 | 0.50 | 0.40 | 0.38 |
| w/c | | | | | | |

As can be seen from FIG. 2, the water demand for a 2-inch slump over the entire range of w/c ratios from 0.42-0.81 varies only about 16 lbs per cubic yard (from 271 to 287 lbs per cubic yard). As soon as the w/c is known for the required strength, the corresponding water demand can be calculated according to the equation of Formula (II). In the instant case, however, for simplicity, a mid range water content was chosen of 280 lbs of water per cubic yard for all the future mixes in the target range. A sensitivity analysis of the effect on the initial slump of choosing 280 lbs per cubic yard over the entire w/c range is shown in FIG. 3. As can be seen from FIG. 3, the implication of choosing the same water content for all mixes over the entire w/c range is only that the initial slump (without plasticizer) will vary from 1.5″ to 3″ which is a very minor variation, and acceptable as the final slump will be achieved after adding HRWR.

The six initial concrete compositions were then cast, and the compositions were allowed to harden and set for 28 days. After 28 days, the compressive strength, measured after each of 3, 7 and 28 days, was plotted as a function of the final w/c and the strength-w/c fingerprint was generated. The fingerprint from testing the six setup mixes is shown in FIG. 4. As can be seen from FIG. 4, the 28-day compressive strength can be described by the equation:

28-day strength=1240.7×w/c^{-1.7338}

It should be noted that all mixes in the plant having a target strength within the strength range of 3,000 to 6,000 psi can be designed using the above equation in which “A” is 1240.7 and “B” is −1.7338, and using a water demand of 280 lbs/yd³.

As a next step, the w/c corresponding to a target compressive strength was calculated using the following equation, which is derived from the above 28-day compressive strength equation:

w/c=e^{((ln(strength)-ln(1240.7))/-1.7338)}

Assuming an overdesign of 10% for the required strengths of 3000, 4000, 5000 and 6000 PSI, the required w/c ratios calculated from the above equation were: 0.57, 0.48, 0.42 and 0.38, respectively. The re-calculated final mixes based on the optimized w/c ratios and a water demand of 280 lbs/yd³ are shown in Table 3.

TABLE 3
Final Mix Designs with 10% Overdesign

Strength (PSI)

| | 3000 | 4000 | 5000 | 6000 |
|---|---|---|---|---|
| Cement | 492 | 581 | 661 | 734 |
| (lbs/yd³) | | | | |
| Sand (lbs/yd³) | 1660 | 1619 | 1582 | 1549 |
| Rock (lbs/yd³) | 1358 | 1325 | 1295 | 1267 |
| Water (lbs/yd³) | 280 | 280 | 280 | 280 |
| AEA | 2.0 | 2.5 | 2.0 | 2.0 |
| (fl.oz./yd³) | | | | |
| HRWR | 38.7 | 44.8 | 47.8 | 47.5 |
| (fl.oz./yd³) | | | | |
| Air | 6.0 | 6.0 | 6.0 | 6.0 |
| (vol. %) | | | | |
| Slump (inch) | 8.0 | 8.0 | 8.0 | 8.0 |
| w/c | 0.57 | 0.48 | 0.42 | 0.38 |

The final mix designs were verified by inputting the final designs in the batch computer and casting cylinders for testing and verification of 3-, 7- and 28-day compressive strengths.

### Example 2

In this Example, a fingerprint curve was generated for a particular concrete manufacturing plant using the computer-implemented methods as described herein.

Specifically, all materials and properties data of the materials from the manufacturing plant were received and entered into a computer in a laboratory. An approximately 5500 PSI concrete mix design (w/c=0.608) was then designed using the fingerprint curve of FIG. 1 with the equation:

28-day strength=2591×w/c^{-1.5058}

Based on previous mix designs from the manufacturing plant, the first mix design for a water demand test was produced as shown in Table 4.

TABLE 4

| | Amount of Component in |
|---|---|
| | Mix Design (lbs/yd³) |
| Cement | 476 |
| Class F Fly Ash | 143 |
| Manufactured Sand | 1641 |
| ¾” Rock | 1284 |
| Water | 279 |

While mixing the components in the laboratory to produce the concrete compositions, additional water, providing a final water demand of 295 lbs/yd³, had to be added in order to achieve a 2″ slump.

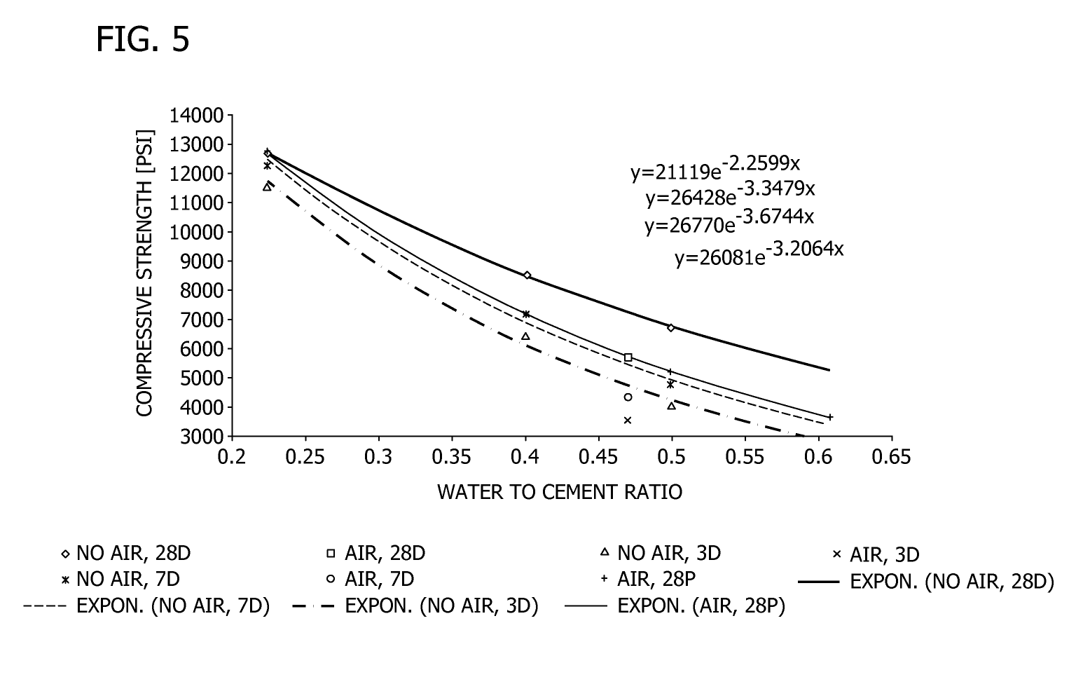

Additional mix designs were produced for: (1) w/c=0.507 and including an air entrainer; (2) w/c=0.538; (3) w/c=0.436; and (4) w/c=0.24. All mix designs were case in cylinders and the concrete strength was tested after 3, 7, and 28 days to generate the fingerprint curves shown in FIG. 5. Based on the 28-day fingerprint curve, mix designs can be prepared equal to the target strength by following the logarithmic curve of:

28-day strength=21119×e^{-2.2599×w/c}

### Example 3

In this Example, a fingerprint curve was generated for a particular concrete manufacturing plant using the computer-implemented methods as described herein.

Specifically, all materials and properties data of the materials from the manufacturing plant were received and entered into a computer in a laboratory. An approximately 5500 PSI concrete mix design (w/c=0.608) was then designed using the fingerprint curve of FIG. 1 with the equation:

28-day strength=2591×w/c^{-1.5058}

Based on previous mix designs from the manufacturing plant, the first mix design for a water demand test was produced as shown in Table 5.

TABLE 5

| | Amount of Component in |
|---|---|
| | Mix Design (lbs/yd³) |
| Cement | 411 |
| Class F Fly Ash | 123 |
| Manufactured Sand | 709 |
| Natural Sand | 1056 |
| ¾” Rock | 1450 |
| Water | 254 |

While mixing the components in the laboratory to produce the concrete compositions, additional water, providing a final water demand of 275 lbs/yd³, had to be added in order to achieve a 2″ slump.

Additional mix designs were produced for: (1) w/c=0.507 and including an air entrainer; (2) w/c=0.538; (3) w/c=0.436; and (4) w/c=0.24. All mix designs were case in cylinders and the concrete strength was tested after 3, 7, and 28 days to generate the fingerprint curves shown in FIG. 5. Based on the 28-day fingerprint curve, mix designs can be prepared equal to the target strength by following the logarithmic curve of:

28-day strength=28295×e^{-2.9689×w/c}

### Example 4

In this Example, a fingerprint curve was generated for a particular concrete manufacturing plant using the computer-implemented methods as described herein.

Specifically, all materials and properties data of the materials from the manufacturing plant were received and entered into a computer in a laboratory. An approximately 5500 PSI concrete mix design (w/c=0.608) was then designed using the fingerprint curve of FIG. 1 with the equation:

28-day strength=2591×w/c^{-1.5058}

Based on previous mix designs from the manufacturing plant, the first mix design for a water demand test was produced as shown in Table 6.

TABLE 6

| | Amount of Component in |
|---|---|
| | Mix Design (lbs/yd³) |
| Cement | 441320 |
| Class C Fly Ash | 692 |
| Manufactured Sand | 1000 |
| Natural Sand | 1402 |
| ¾” Rock | 290 |
| Water | |

While mixing the components in the laboratory to produce the concrete compositions, additional water, providing a final water demand of 325 lbs/yd³, had to be added in order to achieve a 2″ slump.

Additional mix designs were produced for: (1) w/c=0.507 and including an air entrainer; (2) w/c=0.538; (3) w/c=0.436; and (4) w/c=0.24. All mix designs were case in cylinders and the concrete strength was tested after 3, 7, and 28 days to generate the fingerprint curves shown in FIG. 5. Based on the 28-day fingerprint curve, mix designs can be prepared equal to the target strength by following the logarithmic curve of:

28-day strength=40042×e^{-3.6569×w/c}

### Example 5

In this Example, a fingerprint curve was generated for a particular concrete manufacturing plant using the computer-implemented methods as described herein.

Specifically, all materials and properties data of the materials from the manufacturing plant were received and entered into a computer in a laboratory. An approximately 5500 PSI concrete mix design (w/c=0.608) was then designed using the fingerprint curve of FIG. 1 with the equation:

28-day strength=2591×w/c^{-1.5058}

Based on previous mix designs from the manufacturing plant, the first mix design for a water demand test was produced as shown in Table 7.

TABLE 7

| | Amount of Component in Mix Design |
|---|---|
| | (lbs/yd³) |
| Cement | 523 |
| Class F Fly Ash | 157 |
| Natural Sand | 1631 |
| ¾” Rock | 1335 |
| Water | 273 |

While mixing the components in the laboratory to produce the concrete compositions, additional water, providing a final water demand of 284 lbs/yd³, had to be added in order to achieve a 2″ slump.

Additional mix designs were produced for: (1) w/c=0.507 and including an air entrainer; (2) w/c=0.538; (3) w/c=0.436; and (4) w/c=0.24. All mix designs were case in cylinders and the concrete strength was tested after 3, 7, and 28 days to generate the fingerprint curves shown in FIG. 5. Based on the 28-day fingerprint curve, mix designs can be prepared equal to the target strength by following the logarithmic curve of:

28-day strength=26742×e^{-2.8313×w/c}

As various changes could be made in the above constructions and methods without departing from the scope of the invention, it is intended that all matter contained in the above description and shown in the accompanying drawings shall be interpreted as illustrative and not in a limiting sense.

1. A method for designing a concrete composition having optimized compressive strength and slump, the method comprising:
preparing at least one saturated-surface-dry cementitious composition having a compressive strength in a target compressive strength range, the saturated-surface-dry cementitious composition comprising cement, fine aggregate, and coarse aggregate;
determining an amount of water to be added to the saturated-surface-dry cementitious composition to produce a target slump amount;
preparing at least two initial concrete compositions having the amount of water and the target slump amount;
measuring the compressive strength of the initial concrete compositions after a desired time;
determining an amount of overdesign compressive strength for the initial concrete composition; and
determining an optimized water to cement ratio for an overdesigned optimized concrete composition.

2. The method as set forth in claim 1 further comprising preparing the overdesigned optimized concrete composition.

3. The method as set forth in claim 1 further comprising providing the optimized water to cement ratio.

4. The method as set forth in claim 3 wherein the optimized water to cement ratio is provided for storage in a computer memory.

5. The method as set forth in claim 3 wherein the optimized water to cement ratio is provided for display.

6. The method as set forth in claim 3 wherein the optimized water to cement ratio is provided to a person.

7. The method as set forth in claim 3 wherein the determining of an optimized water to cement ratio for an overdesigned optimized concrete composition is done utilizing a computer.

8. The method as set forth in claim 1 wherein the preparing the saturated-surface-dry cementitious composition comprises adjusting the ratio of fine aggregate to coarse aggregate of the saturated-surface-dry cementitious composition depending upon the target compressive strength range.

9. The method as set forth in claim 8 wherein the target compressive strength range is 8000 psi or greater and the ratio of fine aggregate to coarse aggregate is adjusted to about 50:50.

10. The method as set forth in claim 8 wherein the target compressive strength range is less than 8000 psi and the ratio of fine aggregate to coarse aggregate is adjusted to about 55:45.

11. (canceled)

12. The method as set forth in claim 1 wherein the determining of an amount of water to be added to the saturated-surface-dry cementitious compositions comprises continuously adding water to the saturated-surface-dry cementitious compositions until the target slump amount is achieved.

13-15. (canceled)

16. The method as set forth in claim 1 wherein the overdesign compressive strength is from about 10% to about 30% greater than the target compressive strength of the initial concrete compositions after the desired time.

17-18. (canceled)

19. A method for designing a concrete composition having optimized compressive strength and slump, the method comprising:
obtaining a characterization of at least one component of a saturated-surface-dry cementitious composition, the saturated-surface-dry cementitious composition comprising cement, fine aggregate, and coarse aggregate;
preparing at least one saturated-surface-dry cementitious composition having a compressive strength in a target compressive strength range;
determining an amount of water to be added to the saturated-surface-dry cementitious composition to produce a target slump amount;
preparing at least two initial concrete compositions having the amount of water and the target slump amount;
measuring the compressive strength of the initial concrete compositions after a desired time;
determining an amount of overdesign compressive strength for the initial concrete composition; and
determining an optimized water to cement ratio for an overdesigned optimized concrete composition.

20. The method as set forth in claim 19 wherein the characterization of at least one component of a saturated-surface-dry cementitious composition comprises characterizing a property selected from the group consisting of sieve analysis, specific gravity of fine aggregate, specific gravity of coarse aggregate, absorption of fine aggregate, absorption of coarse aggregate, maximum particle packing density, water to cement ratio, and combinations thereof.

21-22. (canceled)

23. The method as set forth in claim 19 wherein the preparing the saturated-surface-dry cementitious composition comprises adjusting the ratio of fine aggregate to coarse aggregate of the saturated-surface-dry cementitious composition depending upon the target compressive strength range.

24-26. (canceled)

27. The method as set forth in claim 19 wherein the determining of an amount of water to be added to the saturated-surface-dry cementitious compositions comprises continuously adding water to the saturated-surface-dry cementitious compositions until the target slump amount is achieved.

28. The method as set forth in claim 19 further comprising adding plasticizer to the saturated-surface-dry cementitious composition to produce the target slump amount.

29. The method as set forth in claim 19 further comprising plotting compressive strength after the desired time versus the water to cement ratio.

30-48. (canceled)

49. A system comprising:
a memory for storing data related to a saturated-surface-dry cementitious composition;
a processor configured to:
receive data from an operator related to a saturated-surface-dry cementitious composition;
calculate an amount of water to be added to the saturated-surface-dry cementitious composition to produce a target slump;
receive data from an operator related to compressive strength;
calculate an amount of overdesign compressive strength;
calculate an optimized water to cement ratio for an overdesigned optimized concrete composition; and
provide the calculated amount of water to be added to the saturated-surface-dry cementitious composition to produce a target slump, the calculated amount of overdesign of compressive strength, and the calculated optimized water to cement ratio for the overdesigned optimized concrete composition for display.

50. The system as set forth in claim 49 wherein the processor is additionally configured to plot compressive strength after a desired time versus a water to cement ratio.
